(19) United States
(12) Patent Application Publication
(10) Pub. No.: US 2026/0285182 A1
(43) Pub. Date: Sep. 24, 2026

(54) A CONTROLLER

(71) Applicant: 3ti Energy Hubs Ltd, Surrey (GB)

(72) Inventor: Mark Potter, Surrey (GB)

(21) Appl. No.: 18/874,392

(22) PCT Filed: Jun. 8, 2023
(86) PCT No.: PCT/EP2023/065374

§ 371 Date: Dec. 12, 2024

(30) Foreign Application Priority Data
Jun. 13, 2022 (GB) 2208595.5

(51) Int. Cl. B60L 53/60; B60L 53/16; B60L 53/51; H02J 3/32; H02J 3/38; H02J 101/24

(52) U.S. Cl. CPC B60L 53/60; B60L 53/16; B60L 53/51; H02J 3/32; H02J 3/38; B60L 2210/30; B60L 2210/40; H02J 2101/24

(57) ABSTRACT

A controller for providing phase balancing for a three phase power supply, wherein a first phase of the three phase power supply is coupled to a first electrical bus, a second phase of the three phase power supply is coupled to a second electrical bus, and a third phase of the three phase power supply is coupled to a third electrical bus, wherein the first electrical bus, the second electrical bus and the third electrical bus are coupled via an inverter to a direct current, DC, bus to which is coupled at least one photovoltaic, PV, panel, wherein the controller comprises a device for monitoring current in the first electrical bus, the second electrical bus and the third electrical bus, wherein the device is arranged to control the inverter to provide current generated by the at least one PV panel to at least one of the first electrical bus, the second electrical bus and the third electrical bus if the current difference between the first electrical bus, the second electrical bus and/or the third electrical bus exceeds a predetermined threshold value to substantially balance the current load on the first electrical bus, the second electrical bus and the third electrical bus.

### BACKGROUND

The present invention relates to a controller, in particular a controller for providing phase balancing to a three phase power supply.

An electrical grid power supply is usually provided via a three phase alternating current (AC) supply, where each phase is shifted by 120 degrees with respect to the other phases.

To aid the reduction of losses within the electrical grid power supply, circuits attached to the power supply are preferably designed to provide equal loads on each phase to provide a balanced load, thereby reducing power losses.

However, with the recent increase in interest in the use of electric vehicles (EV) and the need to rapidly charge a large number of EVs at random intervals, this can result in electrical loads supported on each phase of the electrical grid power supply frequently being changed, which can cause large electrical load imbalances within the electrical grid power supply.

It is desirable to improve this situation.

In accordance with an aspect of the present invention there is provided a controller and method according to the accompanying claims.

The present invention provides a controller for performing phase balancing to a three phase power supply to allow phase balancing between different phases of a multi-phase power supply to be adjusted dynamically. In particular, the controller is arranged to dynamically perform phase balancing in response to changes in loads placed on different phases of the multi-phase power supply.

The present invention will now be described, by way of example, with reference to the accompanying drawings in which:

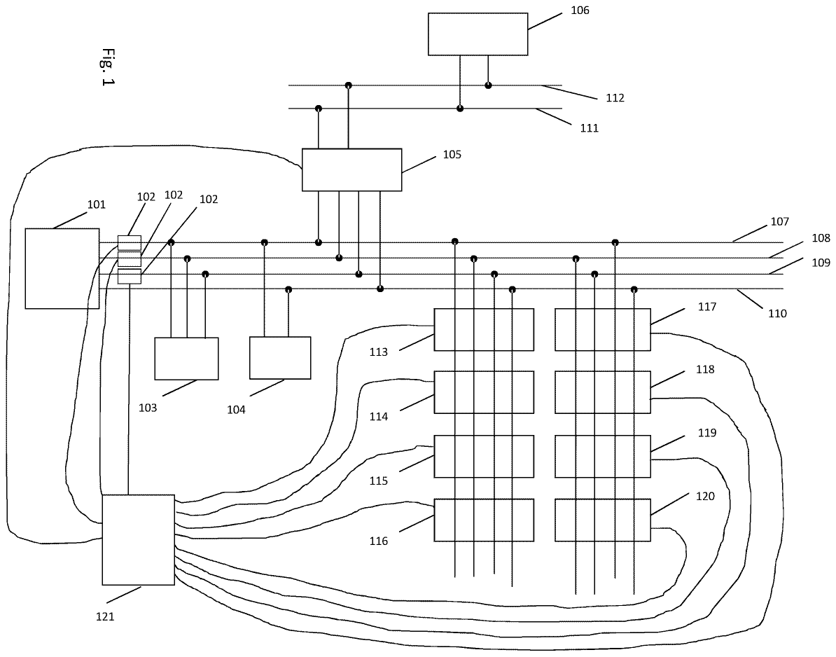

FIG. 1 illustrates a schematic of a phase balancing system in accordance with an aspect of the present invention.

In accordance with an embodiment of the present invention, FIG. 1 illustrates a three phase mains supply 101, otherwise known as a grid supply, to which is coupled a three phase electrical bus, which include three electrical buses 107, 108, 109 and a neutral 110.

Coupled to each of the three electrical buses 107, 108, 109 is a respective current sensor 102, for example a current transformer, which are coupled to a controller 121, where the controller is arranged to monitor the current on each of the electrical busses 107, 108, 109 using the current sensor 102 readings.

Typically, coupled to the three phase electrical bus will be one or more fixed, uncontrolled electrical loads, which in the present embodiment include a first load and a second load. The first load is a three phase device that is coupled to each of the three electrical buses 107, 108, 109. The second load is a single phase device that is coupled to one of the electrical buses 107, 108, 109 and neutral 110. As stated above, the load on the first load and the second load are fixed and uncontrolled. In other words, the current load for the first load and the second load cannot be dynamically varied remotely from the respective loads. Although the present embodiment illustrates two uncontrolled loads being coupled to the three phase mains supply 101, any combination of uncontrolled loads may be coupled to the three phase mains supply 101 or none at all. Preferably, if uncontrolled loads are coupled to the three phase mains supply, the uncontrolled loads are arranged to be balanced across the three electrical phases of the three phase mains supply, in other words, the uncontrolled loads result in a load on each of the three phases that is substantially the same. However, operation or deactivation of the respective uncontrolled loads may result in a load imbalance, for example if one of the uncontrolled loads is a heater, operation of the heater may cause a load imbalance depending on the state of other loads connected to the three phase electrical bus.

Additionally, one or more electric vehicle, EV, charging ports 113, 114, 115, 116, 117, 118, 119, 110 are coupled to the three phase electrical bus 107, 108, 109, 110 to support single phase AC charging of an EV or three phase AC charging. Preferably the EV charging ports will be controlled loads, where the controller can dynamically vary the load that each EV charging port imparts on the electrical system. For example, if an EV charging port is being used to charge an EV that is causing a load imbalance between the different electrical busses 107, 108, 109, the controller 121 can dynamically vary the power provided by the EV charging port to reduce the load imbalance. As such, the controller 121 can control current from an electric vehicle, EV, charging port to an EV if the current difference between the first electrical bus, the second electrical bus and/or the third electrical bus exceeds a predetermined threshold value to substantially balance the current load on the first electrical bus, the second electrical bus and the third electrical bus.

The three phase electrical bus is coupled to a DC bus 111, 112 via an AC/DC converter 105 that can act as an inverter and/or rectifier.

Also coupled to the DC bus 111, 112 is a photovoltaic, PV, panel 106 that is arranged to generate an electrical current when exposed to sunlight. Typically the PV panel will be connected to the DC bus via power control electronics, for example a maximum power point tracker, a DC:DC converter or a pulse width modulation, PWM, controller. Preferably, a DC battery (not shown) is also coupled to the DC bus 111, 112 for storing charge from the three phase mains supply and/or the PV panel 106. The battery may be directly or indirectly connected to the DC bus. If the battery is indirectly connected to the DC bus typically this will be via power control electronics. The PV panel 106 will typically comprise an array of PV panels, as such any reference to PV panel includes an array of PV panels or any other PV panel configuration, for example where one or more maximum power point tracking controllers are coupled to one or more PV arrays.

As stated above, the controller 121 is arranged to monitor the current load on each of the electrical buses 107, 108, 109, wherein the controller 121 is arranged to control the AC/DC converter 105, acting as an inverter, to provide current generated by the PV panel 106 on to one or more of the electrical busses 107, 108, 109 if the current difference between the electrical busses 107, 108, 109 exceeds a predetermined threshold, thereby allowing the current loads on each of the electrical busses 107, 108, 109 to be balanced. The predetermined threshold may be selected based on the electrical bus/load configuration and the electrical losses that may be acceptable resulting from a load imbalance between the electrical busses 107, 108, 109. However, preferably the current difference between the electrical busses 107, 108, 109 will be substantially zero.

For example, if one or more of the charge ports is being used to provide a single phase charge to an EV, which causes a phase imbalance between the electrical busses 107, 108, 109, in addition to or alternatively to controlling the current load of the one or more charge ports, the current generated by the PV panel 106 can be used to balance the current loads between the electrical busses 107, 108, 109 by directing current from the PV panel 106 to one or more of the electrical busses 107, 108, 109. This can also provide the advantage of allowing an EV to be charged using less power from the three phase mains supply 101 than otherwise would be used.

Preferably, to supplement current generated by the PV panel 106, the controller can be arranged to provide current from the battery, via the AC/DC converter operating as an inverter, on to one or more of the electrical busses 107, 108, 109. For example, if the controller 121 has identified a current/phase imbalance on the electrical bus and the current generated by the PV panel 106 is not sufficient to fully balance a current imbalance on the electrical bus, for example during bad weather when little power is generated by the PV panel 106 or at night time when no power is generated by the PV panel 106, the controller can direct current from the battery to one or more of the electrical busses 107, 108, 109 to supplement the current generated by the PV panel 106 to allow the current loads on each of the electrical busses 107, 108, 109 to be balanced.

Additionally, the controller 121 may be configured to control the AC/DC converter 105 to balance the current load on the electrical bus by providing current from one or more of the electrical busses 107, 108, 109 to another one or more of the electrical busses 107, 108, 109, if the current difference between any one of the electrical busses 107, 108, 109 exceeds a predetermined threshold value to substantially balance the current load on the electrical bus. For example, the controller 121 may be configured to balance the current load by transferring current from one electrical bus to another electrical bus if the current generated by the PV panel 106 is not sufficient to fully balance a current imbalance on the electrical bus.

Consequently, the controller can reduce a phase/load imbalance between the electrical buses 107, 108, 109 by controlling a controller load coupled to the electrical bus, by directing current from the PV panel 106 to one or more electrical buses, by directing current from the battery to one or more electrical buses and/or diverting current from one electrical bus to another electrical bus.

### EMBODIMENTS

A controller for providing phase balancing for a three phase power supply, wherein a first phase of the three phase power supply is coupled to a first electrical bus, a second phase of the three phase power supply is coupled to a second electrical bus, and a third phase of the three phase power supply is coupled to a third electrical bus, wherein the first electrical bus, the second electrical bus and the third electrical bus are coupled via an inverter to a direct current, DC, bus to which is coupled at least one photovoltaic, PV, panel, wherein the controller comprises a device for monitoring current in the first electrical bus, the second electrical bus and the third electrical bus, wherein the device is arranged to control the inverter to provide current generated by the at least one PV panel to at least one of the first electrical bus, the second electrical bus and the third electrical bus if the current difference between the first electrical bus, the second electrical bus and/or the third electrical bus exceeds a predetermined threshold value to substantially balance the current load on the first electrical bus, the second electrical bus and the third electrical bus.

Preferably the device is arranged to control the inverter to provide current from a battery coupled to the DC bus to at least one of the first electrical bus, the second electrical bus and the third electrical bus if the current difference between the first electrical bus, the second electrical bus and/or the third electrical bus exceeds a predetermined threshold value to substantially balance the current load on the first electrical bus, the second electrical bus and the third electrical bus.

Preferably the device is arranged to control current from an electric vehicle, EV, charging port to an EV if the current difference between the first electrical bus, the second electrical bus and/or the third electrical bus exceeds a predetermined threshold value to substantially balance the current load on the first electrical bus, the second electrical bus and the third electrical bus, wherein the EV charging port is coupled to the first electrical bus, the second electrical bus and/or the third electrical bus.

Preferably the device is arranged to control a rectifier coupled to the first electrical bus, the second electrical bus and the third electrical bus and the inverter for providing current from one of the first electrical bus, the second electrical bus and the third electrical bus to another one of the electrical buses if the current difference between the first electrical bus, the second electrical bus and/or the third electrical bus exceeds a predetermined threshold value to substantially balance the current load on the first electrical bus, the second electrical bus and the third electrical bus.

A controller for providing phase balancing for a three phase power supply, wherein a first phase of the three phase power supply is coupled to a first electrical bus, a second phase of the three phase power supply is coupled to a second electrical bus, and a third phase of the three phase power supply is coupled to a third electrical bus, wherein the controller comprises a device for monitoring current in the first electrical bus, the second electrical bus and the third electrical bus, wherein the device is arranged to control current from an electric vehicle, EV, charging port to an EV if the current difference between the first electrical bus, the second electrical bus and/or the third electrical bus exceeds a predetermined threshold value to substantially balance the current load on the first electrical bus, the second electrical bus and the third electrical bus, wherein the EV charging port is coupled to the first electrical bus, the second electrical bus and/or the third electrical bus.

A method for providing phase balancing for a three phase power supply, wherein a first phase of the three phase power supply is coupled to a first electrical bus, a second phase of the three phase power supply is coupled to a second electrical bus, and a third phase of the three phase power supply is coupled to a third electrical bus, wherein the first electrical bus, the second electrical bus and the third electrical bus are coupled via an inverter to a direct current, DC, bus to which is coupled at least one photovoltaic, PV, panel, wherein the method comprises monitoring current in the first electrical bus, the second electrical bus and the third electrical bus, and controlling the inverter to provide current generated by the at least one PV panel to at least one of the first electrical bus, the second electrical bus and the third electrical bus if the current difference between the first electrical bus, the second electrical bus and/or the third electrical bus exceeds a predetermined threshold value to substantially balance the current load on the first electrical bus, the second electrical bus and the third electrical bus.

Preferably further comprising controlling the inverter to provide current from a battery coupled to the DC bus to at least one of the first electrical bus, the second electrical bus and the third electrical bus if the current difference between the first electrical bus, the second electrical bus and/or the third electrical bus exceeds a predetermined threshold value to substantially balance the current load on the first electrical bus, the second electrical bus and the third electrical bus.

Preferably further comprising controlling current from an electric vehicle, EV, charging port to an EV if the current difference between the first electrical bus, the second electrical bus and/or the third electrical bus exceeds a predetermined threshold value to substantially balance the current load on the first electrical bus, the second electrical bus and the third electrical bus, wherein the EV charging port is coupled to the first electrical bus, the second electrical bus and/or the third electrical bus.

Preferably further comprising controlling a rectifier coupled to the first electrical bus, the second electrical bus and the third electrical bus and the inverter for providing current from one of the first electrical bus, the second electrical bus and the third electrical bus to another one of the electrical buses if the current difference between the first electrical bus, the second electrical bus and/or the third electrical bus exceeds a predetermined threshold value to substantially balance the current load on the first electrical bus, the second electrical bus and the third electrical bus.

A method for providing phase balancing for a three phase power supply, wherein a first phase of the three phase power supply is coupled to a first electrical bus, a second phase of the three phase power supply is coupled to a second electrical bus, and a third phase of the three phase power supply is coupled to a third electrical bus, wherein the method comprises monitoring current in the first electrical bus, the second electrical bus and the third electrical bus, and controlling current from an electric vehicle, EV, charging port to an EV if the current difference between the first electrical bus, the second electrical bus and/or the third electrical bus exceeds a predetermined threshold value to substantially balance the current load on the first electrical bus, the second electrical bus and the third electrical bus, wherein the EV charging port is coupled to the first electrical bus, the second electrical bus and/or the third electrical bus.

1. A controller for providing phase balancing for a three phase power supply, wherein a first phase of the three phase power supply is coupled to a first electrical bus, a second phase of the three phase power supply is coupled to a second electrical bus, and a third phase of the three phase power supply is coupled to a third electrical bus, wherein the first electrical bus, the second electrical bus and the third electrical bus are coupled via an inverter to a direct current, DC, bus to which is coupled at least one photovoltaic, PV, panel, wherein the controller comprises a device for monitoring current in the first electrical bus, the second electrical bus and the third electrical bus, wherein the device is arranged to control the inverter to provide current generated by the at least one PV panel to at least one of the first electrical bus, the second electrical bus and the third electrical bus and to control current from an electric vehicle, EV, charging port to an EV if the current difference between the first electrical bus, the second electrical bus and/or the third electrical bus exceeds a predetermined threshold value to substantially balance the current load on the first electrical bus, the second electrical bus and the third electrical bus, wherein the EV charging port is coupled to the first electrical bus, the second electrical bus and/or the third electrical bus.

2. A controller according to claim 1, wherein the device is arranged to control the inverter to provide current from a battery coupled to the DC bus to at least one of the first electrical bus, the second electrical bus and the third electrical bus if the current difference between the first electrical bus, the second electrical bus and/or the third electrical bus exceeds a predetermined threshold value to substantially balance the current load on the first electrical bus, the second electrical bus and the third electrical bus.

3. A controller according to claim 1, wherein the device is arranged to control a rectifier coupled to the first electrical bus, the second electrical bus and the third electrical bus and the inverter for providing current from one of the first electrical bus, the second electrical bus and the third electrical bus to another one of the electrical buses if the current difference between the first electrical bus, the second electrical bus and/or the third electrical bus exceeds a predetermined threshold value to substantially balance the current load on the first electrical bus, the second electrical bus and the third electrical bus.

4. A method for providing phase balancing for a three phase power supply, wherein a first phase of the three phase power supply is coupled to a first electrical bus, a second phase of the three phase power supply is coupled to a second electrical bus, and a third phase of the three phase power supply is coupled to a third electrical bus, wherein the first electrical bus, the second electrical bus and the third electrical bus are coupled via an inverter to a direct current, DC, bus to which is coupled at least one photovoltaic, PV, panel, wherein the method comprises monitoring current in the first electrical bus, the second electrical bus and the third electrical bus, and controlling the inverter to provide current generated by the at least one PV panel at least one of the first electrical bus, the second electrical bus and the third electrical bus and to control current from an electric vehicle, EV, charging port to an EV if the current difference between the first electrical bus, the second electrical bus and/or the third electrical bus exceeds a predetermined threshold value to substantially balance the current load on the first electrical bus, the second electrical bus and the third electrical bus, wherein the EV charging port is coupled to the first electrical bus, the second electrical bus and/or the third electrical bus.

5. A method according to claim 4, further comprising controlling the inverter to provide current from a battery coupled to the DC bus to at least one of the first electrical bus, the second electrical bus and the third electrical bus if the current difference between the first electrical bus, the second electrical bus and/or the third electrical bus exceeds a predetermined threshold value to substantially balance the current load on the first electrical bus, the second electrical bus and the third electrical bus.

6. A method according to claim 4, further comprising controlling a rectifier coupled to the first electrical bus, the second electrical bus and the third electrical bus and the inverter for providing current from one of the first electrical bus, the second electrical bus and the third electrical bus to another one of the electrical buses if the current difference between the first electrical bus, the second electrical bus and/or the third electrical bus exceeds a predetermined threshold value to substantially balance the current load on the first electrical bus, the second electrical bus and the third electrical bus.
